(19) United States
(12) Patent Application Publication
(10) Pub. No.: US 2010/0248975 A1
(43) Pub. Date: Sep. 30, 2010

(54) Fluorogenic peptide substrate arrays for highly multiplexed, real-time monitoring of kinase activities

(76) Inventors: Gunjan Tiwari, Sunnyvale, CA (US); Jiangtao Yu, Mountain View, CA (US); Steven Sundberg, San Francisco, CA (US)

Correspondence Address: Pillsbury Winthrop Shaw Pittman LLP;(INTEL), P.O. Box 10500, McLean, VA, 22102, US

(21) Appl. No.: 11/647,579

(22) Filed: Dec. 29, 2006

(51) Int. Cl. C40B 30/04; C40B 40/10

(52) U.S. Cl. 506/9; 506/18

(57) ABSTRACT

The embodiments of the invention relate to a biomolecule microarray comprising a plurality of different polypeptides, where the polypeptides contain a kinase recognition sequence connected via a linker sequence to a metal binding amino acid that undergoes chelation enhanced fluorescence upon binding to a divalent cation. The embodiments further relate to kits comprising the microarray, and methods of using the microarray to screen for kinase activity, and to screen for inhibitors of kinase activity.

### RELATED APPLICATIONS

This application is related to U.S. Ser. Nos. 11/291,296, filed Nov. 30, 2005, and 11/395,899, filed Mar. 30, 2006, the disclosures of which are incorporated herein by reference.

### FIELD OF INVENTION

The embodiments of the invention relate to methods and devices for complex data collection and analysis in multiplexed biomolecule detection of kinase activities. The invention transcends several scientific disciplines such as, biochemistry, physics, microelectronics, immunology, molecular biology, and medical diagnostics.

### BACKGROUND

Phosphorylation and dephosphorylation of proteins mediate signal transduction events that control a multitude of cellular processes including cell division, proliferation, and death. Phosphorylation and dephosphorylation are regulated by kinases and phosphatases, respectively. Protein kinases phosphorylate a substrate by transferring a phosphate group from a high energy donor molecule, ATP, to a target protein. Phosphorylation is primarily directed onto serine, threonine and tyrosine amino acid residues of the target protein. The phosphorylation of the target protein often causes it to be activated, but in some cases may also deactivate the target protein. In order to create a balance of phosphorylation, protein phosphatases remove the phosphates from those target proteins which have been phosphorylated.

Certain kinases and phosphatases are extremely specific, potentially phosphorylating or dephosphorylating only a few target proteins, while others are able to act broadly on many target proteins.

There are over 2000 human genes predicted to code for kinases and potentially each kinase can act on multiple targets making the kinase signaling network immensely complex. Identification of kinase substrate sequences is a critical step towards understanding the biology of these kinases, and provides an important venue for the development of kinase inhibitory and/or phosphatase inhibitory reagents.

The importance of protein kinases in virtually all processes regulating cell survival illustrates the potential for kinases and their cellular substrates as targets for therapeutics. Considerable efforts have been made to elucidate kinase biology by identifying the substrate specificity of kinases and using this information for the prediction of new substrates. Some of the approaches used to date include creation of a database from annotated phosphorylation sites, prediction of substrate sequence patterns from available structures of kinase/peptide substrate complexes, and screening of peptide libraries and peptide arrays (MacBeath G, & Schreiber S L, Science, 2000, 289:1760-1763; Zhu H, et al., Science, 2001, 293:2101-2105.). More recent efforts include attempts to map the phosphoproteome using mass spectroscopy-based techniques. Other efforts include the use of fluorogenic peptides in solution-based assays (Shults et al., J. Am. Chem. Soc., 2003, 125:14248-14249; Shults et al., J. Am. Chem. Soc., 2003, 125:10591-10597, Shults et al., Nat. Methods, 2005, 2:277-283, U.S. Pat. No. 6,906,194, and U.S. Patent Publication Nos. 20050080243 and 20060234206). While these studies have provided some information about kinase biology, they have been severely limited by their complexity, expense, lack of sensitivity, the use of non-structured peptides, solution-based nature and/or by poor representation of potential substrates in the screens. There is a need for methods and compositions that provide large numbers of kinases and/or kinase substrates in a configuration that can be used to identify these substrates and compounds that affect phosphorylation and/or dephosphorylation of the substrates. An important step toward unraveling this complexity is the development of new proteomic technologies that can quantitatively monitor kinase activity in a multiplex fashion. Microarrays offer a convenient platform for multiplex protein analysis.

### BRIEF DESCRIPTION OF THE DRAWINGS

FIG. 1 shows an exemplary microarray of the invention, demonstrating on example of a polypeptide that undergoes chelation enhanced fluorescence.

FIGS. 2A-E and FIG. 2G shows an exemplary method for synthesizing an array of the invention.

FIGS. 3A and B demonstrate exemplary kinase recognition sequences (SEQ ID NOs:10-15) and a schematic of a kinase recognition site array.

FIGS. 4A-C demonstrate the fluorescence in exemplary kinase arrays.

### DETAILED DESCRIPTION

As used in the specification and claims, the singular forms “a”, “an” and “the” include plural references unless the context clearly dictates otherwise. For example, the term “an array” may include a plurality of arrays unless the context clearly dictates otherwise.

An “array,” “macroarray” or “microarray” is an intentionally created collection of substances, such as molecules, openings, microcoils, detectors and/or sensors, attached to or fabricated on a substrate or solid surface, such as glass, plastic, silicon chip or other material forming an array. The arrays can be used to measure the expression levels of large numbers, e.g., tens, thousands or millions, of reactions or combinations simultaneously. An array may also contain a small number of substances, e.g., a few or a dozen. The substances in the array can be identical or different from each other. The array can assume a variety of formats, e.g., libraries of soluble molecules; libraries of compounds tethered to resin beads, silica chips, or other solid supports. The array could either be a macroarray or a microarray, depending on the size of the pads on the array. A macroarray generally contains pad sizes of about 300 microns or larger and can be easily imaged by gel and blot scanners. A microarray would generally contain pad sizes of less than 300 microns.

Synthesis of high density macromolecular arrays is known. Such high density macromolecular arrays include nucleic acid arrays, peptide arrays, and carbohydrate arrays. See, for example, the U.S. Pat. Nos. 5,143,854, 5,384,261, 5,405,783, and 5,424,186.

One method of preparing macromolecular arrays involves photolithographic techniques using photocleavable protecting groups. Briefly, the method includes attaching photoremovable groups to the surface of a substrate, exposing selected regions of the substrate to light to activate those regions, attaching a monomer with a photoremovable group to the activated regions, and repeating the steps of activation and attachment until macromolecules of the desired length and sequence are synthesized. See U.S. Pat. Nos. 5,324,663, 5,384,261, 5,405,783, and 5,412,087.

Additional methods and techniques applicable to array synthesis have been described in the U.S. Pat. Nos. 5,424,186, 5,445,934, 5,451,683, 5,482,867, 5,489,678, 5,491,074, 5,510,270, 5,527,681, 5,550,215, 5,571,639, 5,593,839, 5,599,695, 5,624,711, 5,631,734, 5,677,195, 5,744,101, 5,744,305, 5,753,788, 5,770,456, 5,831,070, and 5,856,011.

A “biochip” is a collection of miniaturized test sites (microarrays) arranged on a solid substrate that permits many tests to be performed at the same time in order to achieve higher throughput and speed. Typically, a biochip's surface area is no larger than a fingernail. Like a computer chip that can perform millions of mathematical operations in one second, a biochip can perform thousands of biological reactions, such as decoding genes, in a few seconds. A genetic biochip is designed to “freeze” into place the structures of one or more strands of biological molecule such as DNA, RNA, protein, peptide, etc. Effectively, it is used as a kind of “test tube” for real chemical samples. A specially designed instrument can determine where the sample hybridized with the biological strands in the biochip.

“Substrate,” “support” and “solid support” refer to a material or group of materials having a rigid or semi-rigid surface or surfaces. In some aspects, at least one surface of the solid support will be substantially flat, although in some aspects it may be desirable to physically separate synthesis regions for different molecules with, for example, wells, raised regions, pins, etched trenches, or the like. In certain aspects, the solid support(s) will take the form of beads, resins, gels, microspheres, or other geometric configurations.

The term “analyte,” “target” or “target molecule” refers to a molecule of interest that is to be detected and/or analyzed, e.g., a nucleotide, an oligonucleotide, a polynucleotide, a peptide, or a protein. The analyte, target or target molecule could be a small molecule, biomolecule, or nanomaterial such as but not necessarily limited to a small molecule that is biologically active, nucleic acids and their sequences, peptides and polypeptides, as well as nanostructure materials chemically modified with biomolecules or small molecules capable of binding to molecular probes such as chemically modified carbon nanotubes, carbon nanotube bundles, nanowires, nanoclusters or nanoparticles. The target molecule may be a fluorescently labeled antigen, antibody, polypeptide, DNA or RNA. A “bioanalyte” refers to an analyte that is a biomolecule.

By “analyte” is further meant any molecule or compound. An analyte can be in the solid, liquid, gaseous or vapor phase. By “gaseous or vapor phase analyte” is meant a molecule or compound that is present, for example, in the headspace of a liquid, in ambient air, in a breath sample, in a gas, or as a contaminant in any of the foregoing. It will be recognized that the physical state of the gas or vapor phase can be changed by pressure, temperature as well as by affecting surface tension of a liquid by the presence of or addition of salts etc.

The term analyte further includes polypeptide analytes such as those polypeptides defined below.

The analyte may be a molecule found directly in a sample such as a body fluid from a host. The sample can be examined directly or may be pretreated to render the analyte more readily detectible. Furthermore, the analyte of interest may be determined by detecting an agent. probative of the analyte of interest such as a specific binding pair member complementary to the analyte of interest, whose presence will be detected only when the analyte of interest is present in a sample. Thus, the agent probative of the analyte becomes the analyte that is detected in an assay. The body fluid can be, for example, urine, blood, plasma, serum, saliva, semen, stool, sputum, cerebral spinal fluid, tears, mucus, and the like. Alternatively, the analyte can be present in a crude cellular extract. In one embodiment, the cells are treated with a test compound prior to isolating the kinase or preparing the crude cellular extract. In other embodiments, the cells are not treated with a test compound.

By a “compound,” “test compound,” or “candidate compound” is meant a chemical molecule, be it naturally-occurring or artificially-derived, and includes, for example, peptides, proteins, synthetic organic molecules, naturally-occurring organic molecules, nucleic acid molecules, and components thereof.

Bioanalyte can also be complex of molecules or compounds in organized or random fashion, such cells, virus, bacteria, fungi, etc.

“Specific binding” is the specific recognition of one of two different molecules for the other compared to substantially less recognition of other molecules. Generally, the molecules have areas on their surfaces or in cavities giving rise to specific recognition between the two molecules. Exemplary of specific binding are antibody-antigen interactions, enzyme—substrate interactions, polynucleotide hybridization interactions, and so forth.

“Non-specific binding” is non-covalent binding between molecules that is relatively independent of specific surface structures. Non-specific binding may result from several factors including hydrophobic interactions between molecules.

The term “capture molecule” refers to a molecule that is immobilized on a surface. The capture molecule generally, but not necessarily, binds to or is in association with a target or target molecule. The capture molecule is typically an antibody, a nucleotide, an oligonucleotide, a polynucleotide, a polypeptide, or a protein, but could also be a small molecule, biomolecule, or nanomaterial such as but not necessarily limited to a small molecule that is biologically active, nucleic acids and their sequences, peptides and polypeptides, as well as nanostructure materials chemically modified with biomolecules or small molecules capable of binding to a target molecule that is bound to a probe molecule to form a complex of the capture molecule, target molecule and the probe molecule. The capture molecule may be fluorescently labeled antibody, protein, polypeptide, DNA or RNA. The capture molecule may or may not be capable of binding to just the target molecule or just the probe molecule.

The term “probe” or “probe molecule” refers to a molecule that binds to a target molecule or capture molecule for the analysis of the target. The probe or probe molecule is generally, but not necessarily, has a known molecular structure or sequence. The probe or probe molecule may or may not be attached to the substrate of the array. The probe or probe molecule is typically an antibody, a nucleotide, an oligonucleotide, a polynucleotide, a divalent cation, a peptide, or a protein, including, for example, monoclonal antibody, cDNA or pre-synthesized polynucleotide deposited on the array. Probes molecules are biomolecules capable of undergoing binding or molecular recognition events with target molecules. (In some references, the terms “target” and “probe” are defined opposite to the definitions provided here.)

A “binding partner,” refers to a molecule or aggregate that has binding affinity for one or more analytes, targets or other molecules. In this sense, a binding partner is either a “capture molecule” or a “probe molecule.” Within the scope of the embodiments of the invention, virtually any molecule or aggregate that has a binding affinity for an analyte or target of interest may be a binding partner, including, but are not limited to, polyclonal antibodies, monoclonal antibodies, single-chain antibodies, chimeric antibodies, humanized antibodies, antibody fragments, oligonucleotides, divalent cations, polynucleotides, nucleic acids, aptamers, nucleic acid ligands and any other known ligand that can bind to at least one target molecule. Although, in certain embodiments a binding partner is specific for binding to a single target, in other embodiments the binding partner may bind to multiple targets that possess similar structures or binding domains.

In one aspect, it is contemplated that the binding partner is an enzyme that has binding affinity for its ligand, also called its substrate. Typically only a very small portion of an enzyme (around 3-4 amino acids) is directly involved in catalysis of its ligand. This region of the enzyme is called the catalytic site or catalytic residues. The region of the enzyme that binds the ligand and then carries out the reaction is known as the active site. The active site also contains the catalytic residues.

Some enzymes do not need any additional components to show full activity. However, others require non-protein molecules to be bound for activity. For example, enzymes can also contain sites that bind cofactors, which may be needed for catalysis. Cofactors can be either inorganic (e.g., metal ions and iron-sulfur clusters) or organic compounds, (e.g., flavin and heme). Organic cofactors (coenzymes) are usually prosthetic groups, which are tightly bound to the enzymes that they assist. These tightly-bound cofactors are distinguished from other coenzymes, such as NADH, since they are not released from the active site during the reaction. Some enzymes also have binding sites for small molecules, which are often direct or indirect products or substrates of the reaction catalyzed. This binding can serve to increase or decrease the enzyme's activity, providing a means for feedback regulation.

“Binding” refers to an interaction between two or more substances, such as between a target and a capture or probe molecule, that results in a sufficiently stable complex so as to permit detection of the bound molecule complex. In certain embodiments of the invention, binding may also refer to an interaction between a second molecule and a target. In one embodiment, an enzyme binds to its ligand and modifies the ligand in a manner that is detectable.

“Associated with” or “association” refers to a direct or indirect interactions between two or more substances, such as between a target and a capture or probe molecule, that results in a sufficiently stable complex. For example, a molecule or complex of molecules is “associated with” the surface of a substrate when the molecule or complex is either bound to the surface of the substrate directly, through another molecule or substance, or to both. In other words, substances are “associated with” each other when any one member of the substances is directly bound to at least another member of the substances. Additionally, a component of an integrated device is also “associated with” the device. For example, a transistor in an integrated circuit is “associated with” the circuit.

The term “kinase” refers to an enzyme of the transferase class that catalyzes the phosphorylation of serine, threonine, or tyrosine groups in enzymes and other proteins, using ATP as a phosphate donor. Non-limiting examples of kinases include ABL1, FMS, ALK, BLK, EphB2, FER, FLT3, Fyn, IGF-1R, IR, IRR, JAK2/3, LCK, LynA, MERTK, MUSK, TRKA, PDGFRα, PDGFRβ, FAK, ROS1, and Src.

The term “isolated” includes a material removed from its original environment, e.g., the natural environment if it is naturally occurring. For example, a naturally occurring polynucleotide or polypeptide present in a living animal is not isolated, but the same polynucleotide or polypeptide, separated from some or all of the coexisting materials in the natural system, is isolated. Such polynucleotides could be part of a vector and/or such polynucleotides or polypeptides could be part of a composition, and still be isolated in that such vector or composition is not part of its natural environment. As used herein, an isolated material or composition can also be a “purified” composition, i.e., it does not require absolute purity; rather, it is intended as a relative definition.

As used herein, the terms “contacting” and “administering” are used interchangeably, and refer to a process by which a test compound is delivered to a cell, either in vitro, in vivo, or ex vivo, or is delivered to an array of the present invention.

By “modulate” and “modulation” is meant that the phosphorylation of a target polypeptide is up regulated or down regulated, such that phosphorylation is greater than or less than that observed in the absence of the modulator. For example, the term “modulate” can mean “inhibit” and within the scope of the invention, the preferred form of modulation is inhibition but the use of the word “modulate” is not limited to this definition.

By “inhibit” it is meant that the level of phosphorylation of a target polypeptide is reduced below that observed in the absence of the test compound.

As used herein, the term “immobilization” refers to the attachment or entrapment, either chemically or otherwise, of a material to another entity (e.g., a solid support) in a manner that restricts the movement of the material.

The terms “label,” “tag” and “sensor compound” are used interchangeably to refer to a marker or indicator distinguishable by the observer but not necessarily by the system used to identify an analyte or target. A label may also achieve its effect by undergoing a pre-designed detectable process. Labels are often used in biological assays to be conjugated with, or attached to, an otherwise difficult to detect substance. At the same time, labels usually do not change or affect the underlining assay process. A label or tag used in biological assays include, but not limited to, a radio-active material, a magnetic material, quantum dot, an enzyme, a liposome-based label, a chromophore, a fluorophore, a dye, a nanoparticle, a quantum dot or quantum well, a composite-organic-inorganic nano-cluster, a colloidal metal particle, or a combination thereof.

The terms “die,” “polymer array chip,” “array,” “array chip,” or “bio-chip” are used interchangeably and refer to a collection of a large number of capture molecules arranged on a shared substrate which could be a portion of a silicon wafer, a nylon strip or a glass slide. The term “DNA array” or “DNA array chip” is used when the array chip is used to analyze a nucleotide. The term “protein array” is used when the array chip is used to analyze a protein.

The term “chip” or “microchip” refers to a microelectronic device made of semiconductor material and having one or more integrated circuits or one or more devices. A “chip” or “microchip” is typically a section of a wafer and made by slicing the wafer. A “chip” or “microchip” may comprise many miniature transistors and other electronic components on a single thin rectangle of silicon, sapphire, germanium, silicon nitride, silicon germanium, or of any other semiconductor material. A microchip can contain dozens, hundreds, or millions of electronic components. A chip could be a biochip, for example.

“Predefined region” or “spot” or “pad” refers to a localized area on a solid support which is, was, or is intended to be used for formation of a selected molecule and is otherwise referred to herein in the alternative as a “selected” region. The predefined region may have any convenient shape, e.g., circular, rectangular, elliptical, wedge-shaped, etc. For the sake of brevity herein, “predefined regions” are sometimes referred to simply as “regions” or “spots.” In some embodiments, a predefined region and, therefore, the area upon which each distinct molecule is synthesized is smaller than about 1 cm² or less than 1 mm², and still more preferably less than 0.5 mm². In most preferred embodiments the regions have an area less than about 10,000 μm² or, more preferably, less than 100 μm². Additionally, multiple copies of the polymer can be synthesized within any preselected region. The number of copies can be in the thousands to the millions. In some aspects, a predefined region can be achieved by physically separating the regions (i.e., beads, resins, gels, etc) into wells, trays, etc.

“Micro-Electro-Mechanical System (MEMS)” is the integration of mechanical elements, sensors, actuators, and electronics on a common silicon substrate through microfabrication technology. While the electronics are fabricated using integrated circuit (IC) process sequences (e.g., CMOS, Bipolar, or BICMOS processes), the micromechanical components could be fabricated using compatible “micromachining” processes that selectively etch away parts of the silicon wafer or add new structural layers to form the mechanical and electromechanical devices. Microelectronic integrated circuits can be thought of as the “brains” of a system and MEMS augments this decision-making capability with “eyes” and “arms”, to allow microsystems to sense and control the environment. Sensors gather information from the environment through measuring mechanical, thermal, biological, chemical, optical, and magnetic phenomena. The electronics then process the information derived from the sensors and through some decision making capability direct the actuators to respond by moving, positioning, regulating, pumping, and filtering, thereby controlling the environment for some desired outcome or purpose. Because MEMS devices are manufactured using batch fabrication techniques similar to those used for integrated circuits, unprecedented levels of functionality, reliability, and sophistication can be placed on a small silicon chip at a relatively low cost.

“Microprocessor” is a processor on an integrated circuit (IC) chip. The processor may be one or more processor on one or more IC chip. The chip is typically a silicon chip with thousands of electronic components that serves as a central processing unit (CPU) of a computer or a computing device.

A “macromolecule” or “polymer” comprises two or more monomers covalently joined. The monomers may be joined one at a time or in strings of multiple monomers, ordinarily known as “oligomers.” Thus, for example, one monomer and a string of five monomers may be joined to form a macromolecule or polymer of six monomers. Similarly, a string of fifty monomers may be joined with a string of hundred monomers to form a macromolecule or polymer of one hundred and fifty monomers. The term polymer as used herein includes, for example, both linear and cyclic polymers of nucleic acids, polynucleotides, polynucleotides, polysaccharides, oligosaccharides, proteins, polypeptides, peptides, phospholipids and peptide nucleic acids (PNAs). The peptides include those peptides having either α-, β-, or ω-amino acids. In addition, polymers include heteropolymers in which a known drug is covalently bound to any of the above, polyurethanes, polyesters, polycarbonates, polyureas, polyamides, polyethyleneimines, polyarylene sulfides, polysiloxanes, polyimides, polyacetates, or other polymers which will be apparent upon review of this disclosure.

The term “biomolecule” refers to any organic molecule that is part of a living organism. Biomolecules includes a nucleotide, a polynucleotide, an oligonucleotide, a peptide, a protein, a ligand, a receptor, among others. A “complex of a biomolecule” refers to a structure made up of two or more types of biomolecules. Examples of a complex of biomolecule include a cell or viral particles, or a portion of a cell such as a cell extract. A cell can include bacteria, fungi, animal mammalian cell, for example.

When the macromolecule of interest is a peptide, the amino acids can be any amino acids, including α, β, or ω-amino acids. When the amino acids are α-amino acids, either the L-optical isomer or the D-optical isomer may be used. Additionally, unnatural amino acids, for example, β-alanine, phenylglycine and homoarginine are also contemplated by the embodiments of the invention. The use of amino acids that bind metals is also contemplated. Such metals include the divalent cations Pb²⁺, Zn²⁺, Mg²⁺, Mn²⁺, and Ca²⁺. These and other amino acids are well-known in the art.

A “peptide” or “polypeptide” is a polymer in which the monomers are amino acids and which are joined together through amide bonds and alternatively referred to as a polypeptide. In the context of this specification it should be appreciated that the amino acids may be the L-optical isomer or the D-optical isomer. Peptides are two or more amino acid monomers long, and often more than 20 amino acid monomers long.

A “protein” is a long polymer of amino acids linked via peptide bonds and which may be composed of two or more polypeptide chains. More specifically, the term “protein” refers to a molecule composed of one or more chains of amino acids in a specific order; for example, the order as determined by the base sequence of nucleotides in the gene coding for the protein. Proteins are essential for the structure, function, and regulation of the body's cells, tissues, and organs, and each protein has unique functions. Examples are hormones, enzymes, and antibodies.

The term “sequence” refers to the particular ordering of monomers within a macromolecule and it may be referred to herein as the sequence of the macromolecule.

A “ligand” is a molecule or a portion of a molecule that is recognized by a particular receptor. Examples of ligands that can be investigated by this invention include, but are not restricted to, agonists and antagonists for cell membrane receptors, toxins and venoms, viral epitopes, hormones, hormone receptors, peptides, enzymes, enzyme substrates, cofactors, drugs (e.g. opiates, steroids, etc.), lectins, sugars, polynucleotides, nucleic acids, oligosaccharides, proteins, monoclonal antibodies, and portions or fragments thereof. In one aspect, the ligand is a polypeptide that can be a substrate for a kinase.

A “receptor” is molecule that has an affinity for a given ligand. Receptors may-be naturally-occurring or manmade molecules. Also, they can be employed in their unaltered state or as aggregates with other species. Receptors may be attached, covalently or noncovalently, to a binding member, either directly or via a specific binding substance. Examples of receptors which can be employed by this invention include, but are not restricted to, antibodies, cell membrane receptors, enzymes, monoclonal antibodies and antisera reactive with specific antigenic determinants (such as on viruses, cells or other materials), drugs, polynucleotides, nucleic acids, peptides, cofactors, lectins, sugars, polysaccharides, cells, cellular membranes, and organelles. Receptors are sometimes referred to in the art as anti-ligands. As the term “receptors” is used herein, no difference in meaning is intended. A “Ligand Receptor Pair” is formed when two macromolecules have combined through molecular recognition to form a complex. Other examples of receptors which can be investigated by this invention include but are not restricted to:

a) Microorganism receptors: Determination of ligands which bind to receptors, such as specific transport proteins or enzymes essential to survival of microorganisms, is useful in developing a new class of antibiotics. Of particular value would be antibiotics against opportunistic fungi, protozoa, and those bacteria resistant to the antibiotics in current use.

b) Enzymes: For instance, one type of receptor is the binding site of enzymes such as protein kinases; determination of ligands (or the determination of the sequence of the portion of the ligand) which bind to the kinases and are in turn phosphorylated by the kinases is useful in the development of drugs which can be used in the treatment of various disorders characterized by increased or decreased kinase expression or increased or decreased kinase activity levels.

c) Antibodies: For instance, the invention may be useful in investigating the ligand-binding site on the antibody molecule which combines with the epitope of an antigen of interest; determining a sequence that mimics an antigenic epitope may lead to the-development of vaccines of which the immunogen is based on one or more of such sequences or lead to the development of related diagnostic agents or compounds useful in therapeutic treatments such as for auto-immune diseases (e.g., by blocking the binding of the “anti-self” antibodies).

d) Nucleic Acids: Sequences of nucleic acids may be synthesized to establish DNA or RNA binding sequences.

e) Catalytic Polypeptides: Polymers, preferably polypeptides, which are capable of promoting a chemical reaction involving the conversion of one or more reactants to one or more products. Such polypeptides generally include a binding site specific for at least one reactant or reaction intermediate and an active functionality proximate to the binding site, which functionality is capable of chemically modifying the bound reactant.

f) Hormone receptors: Examples of hormones receptors include, e.g., the receptors for insulin and growth hormone. Determination of the ligands which bind with high affinity to a receptor is useful in the development of, for example, an oral replacement of the daily injections which diabetics take to relieve the symptoms of diabetes. Other examples are the vasoconstrictive hormone receptors; determination of those ligands which bind to a receptor may lead to the development of drugs to control blood pressure.

g) Opiate receptors: Determination of ligands which bind to the opiate receptors in the brain is useful in the development of less-addictive replacements for morphine and related drugs.

A “fluorophore” or “fluorescent compound” can include, but is not limited to, a dye, intrinsically fluorescent protein or amino acid, lanthanide phosphor, and the like. Dyes, for example, include rhodamine and derivatives, such as Texas Red, ROX (6-carboxy-X-rhodamine), rhodamine-NHS, and TAMRA (5/6-carboxytetramethyl rhodamine NHS); fluorescein and derivatives, such as 5-bromomethyl fluorescein and FAM (5′-carboxyfluorescein NHS), Lucifer Yellow, IAEDANS, 7-Me₂, N-coumarin-4-acetate, 7-OH-4-CH₃-coumarin-3-acetate, 7-NH₂-4CH₃-coumarin-3-acetate (AMCA), monobromobimane, pyrene trisulfonates, such as Cascade Blue, and monobromotrimethyl-ammoniobimane.

Fluorescent amino acids include for example, amino acids comprising a compound that undergoes chelation-enhanced fluorescence upon binding a divalent cation. In one example, the amino acid comprises a compound having the formula (I)

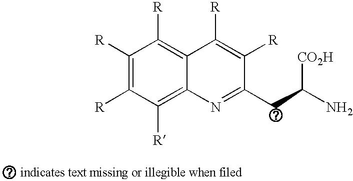

where at least one R group is —SO₂X, where X is OR″ or —NR″R′″; R′ is hydroxy, amino, or thiol; R″ is C₁₋₆ alkyl; R′″ is hydrogen or alkyl; and N is 1, 2, or 3. In a further embodiment, the amino acid comprises a compound having the formula (II)

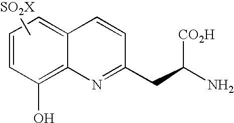

where X is OR″ or —NR″R′″; R″ is C₁₋₆ alkyl; and R′″ is hydrogen or C₁₋₆ alkyl. In another embodiment, the metal binding amino acid comprises a compound of the formula (III)

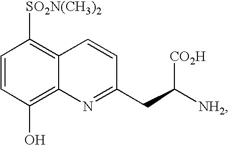

commonly referred to as “Sox”. These metal binding amino acids can be prepared, for example, as shown in Shults et al., J. Am. Chem. Soc. (2003), 125:10591-10597.

The term “complementary” refers to the topological compatibility or matching together of interacting surfaces of a ligand molecule and its receptor. Thus, the receptor and its ligand can be described as complementary, and furthermore, the contact surface characteristics are complementary to each other.

The term “wafer” means a semiconductor substrate. A wafer could be fashioned into various sizes and shapes. It could be used as a substrate for a microchip. The substrate could be overlaid or embedded with circuitry, for example, a pad, via, an interconnect or a scribe line. The circuitry of the wafer could also serve several purposes, for example, as microprocessors, memory storage, and/or communication capabilities. The circuitry can be controlled by the microprocessor on the wafer itself or controlled by a device external to the wafer. In one aspect, the wafer is silicon-based.

The term “resist” or “photoresist” is an organic or inorganic compound that experiences a change in solubility in a developer solution when exposed to ultraviolet (UV) light. Photoresists used in wafer fabrication are applied to the wafer surface as a liquid or vapor and dried into a film. A resist is used as a thin layer to transfer a circuit pattern to the semiconductor substrate which it is deposited upon. A resist can be patterned via lithography to form a (sub)micrometer-scale, temporary mask that protects selected areas of the underlying substrate during subsequent processing steps. The material used to prepare said thin layer (typically a viscous solution). Resists are generally proprietary mixtures of a polymer or its precursor and other small molecules (e.g. photoacid generators) that have been specially formulated for a given lithography technology. Resists used during photolithography are called photoresists. Photoresists are classified into two groups, positive resists and negative resists. A “positive resist” is a type of photoresist in which the portion of the photoresist that is exposed to light becomes soluble to the photoresist developer and the portion of the photoresist that is unexposed remains insoluble to the photoresist developer. A “negative resist” is a type of photoresist in which the portion of the photoresist that is exposed to light becomes relatively insoluble to the photoresist developer. The unexposed portion of the photoresist is dissolved by the photoresist developer.

Photoresists are most commonly used at wavelengths in the ultraviolet spectrum or shorter (<400 nm). For example, some resists absorb strongly from approximately 300 nm to 450 nm. In the deep ultraviolet (DUV) spectrum, the π-π* electronic transition in benzene (link) or carbon double-bond chromophores (link) appears at around 200 nm. Photoresists can also be exposed by electron beams, producing the same results as exposure by light. One very common positive photoresist used with the I, G and H-lines from a mercury-vapor lamp is based on a mixture of Diazonaphthoquinone (DNQ) and Novolac resin (a phenol formaldehyde resin). DNQ inhibits the dissolution of the novolac resin, however, upon exposure to light, the dissolution rate increases even beyond that of pure novolac. One very common negative photoresist is based on epoxy-based polymer. The common product name is SU-8 photoresist.

Deep Ultraviolet (DUV) resist are typically polyhydroxystyrene-based polymers with a photoacid generator providing the solubility change. However, this material does not experience the diazocoupling. The combined benzene-chromophore and DNQ-novolac absorption mechanisms lead to stronger absorption by DNQ-novolac photoresists in the DUV, requiring a much larger amount of light for sufficient exposure. The strong DUV absorption results in diminished photoresist sensitivity.

Photoresists used in production for DUV and shorter wavelengths require the use of chemical amplification to increase the sensitivity to the exposure energy. This is done in order to combat the larger absorption at shorter wavelengths. Chemical amplification is also often used in electron-beam exposures to increase the sensitivity to the exposure dose. In the process, acids released by the exposure radiation diffuse during the post-exposure bake step. These acids render surrounding polymer soluble in developer. A single acid molecule can catalyze many such ‘deprotection’ reactions; hence, fewer photons or electrons are needed.

The term “developer” or “photographic developer” is a chemical that reacts with a chemical that has been exposed to light. Positive photoresist developer could be a hydrated alkaline material which dissolves readily in water, giving a buffered alkaline solution for development of novalak polymer films used in micro imaging, for example. Photoresist developer should preferably provide flat trace sidewalls consistently over its useful life, and should be used in automated spray equipment, preferably with pH controlled additions. Some developers are capable of absorbing CO₂ from the air and thus lowering its pH. During processing, nitrogen blanket or a floating lid could be used to minimize exposure to air to maintain its effectiveness; fresh developer is generally used with spray systems.

The term “reticle” refers to a transparent, semi-transparent or opaque plate that has a pattern image to be transferred to a photoresist coating on a wafer. A reticle contains the pattern image for only part of the wafer. Reticles are generally used for step-and-repeat steppers and step-and-scan systems for wafer fabrication. A “mask” or “photomask” contains the pattern image for a complete or substantially complete wafer die array and the pattern is usually transferred in a single exposure, typically using 1:1 image transfer methods such as contact aligner, proximity aligner or scanning projection aligner (scanner).

A “protecting group” is a group which is bound to a molecule and designed to block a reactive site in a molecule, but may be removed upon exposure to an activator or a deprotecting reagent. Examples of protecting groups include t-BOC and FMOC. Deprotecting reagents include, for example, acids and bases. Protecting groups can be bound to a monomer, a polymer, a linker molecule or a monomer, or polymer, or a linker molecule attached to a solid support to protect a reactive functionality on the monomer, polymer, or linker molecule.

A “linker” molecule typically is a molecule inserted into the growing polymer that does not necessarily convey functionality to the resulting peptide, such as molecular recognition functionality, but instead elongates the distance between the substrate surface and the peptide functionality to enhance the exposure of the peptide functionality on the surface of the substrate. Alternatively, the linker provides a distance between regions or sites of the polymer. Preferably a linker should be about 4 to about 40 atoms long to provide exposure. The linker molecules may be, for example, aryl acetylene, ethylene glycol oligomers containing 2-10 monomer units (PEGs), diamines, diacids, amino acids, among others, and combinations thereof. Examples of diamines include ethylene diamine and diamino propane. Alternatively, the linkers may be the same molecule type as that being synthesized (i.e., nascent polymers), such as polypeptides and polymers of amino acid derivatives such as for example, amino hexanoic acids. In one aspect, the linker is between 0 and 10 amino acids in length.

The term “derivatization” refers to a technique used in chemistry which transforms a chemical compound into a product of similar chemical structure, called derivative. Generally, a specific functional group of the compound participates in the derivatization reaction and transforms the educt to a derivate of deviating reactivity, solubility, boiling point, melting point, aggregate state, or chemical composition. Resulting new chemical properties can be used for quantification or separation of the educt. Derivatization techniques are frequently employed in chemical analysis of mixtures and in surface analysis, e.g. in XPS where newly-incorporated atoms label characteristic groups. For example, in the in situ peptide synthesis process described in the Examples, the solid support is derivatized by amino silanes to impart amino functionality to the surface so that next building block (an amino acid or PEG linker) can be coupled to it.

Embodiments of the invention relate to devices and methods for the real-time detection of kinase activity, or the real-time detection of modulated kinase activity in the presence of a test compound. The device typically is a positionally addressable array comprising a plurality of different polypeptides immobilized on a substrate, wherein the polypeptides comprise a kinase recognition sequence joined by a linker sequence to a metal binding amino acid. Other embodiments relate to kits comprising the array, and to methods of using the arrays to determine targets of kinase activity, and/or modulators of kinase activity.

In one aspect, the metal binding amino acid comprises a compound having the formula (I)

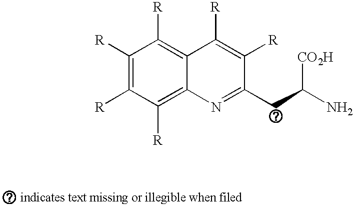

where at least one R group is —SO₂X, where X is OR″ or —NR″R′″; R′ is hydroxy, amino, or thiol; R″ is C₁₋₆ alkyl; R′″ is hydrogen or alkyl; and N is 1, 2, or 3; and wherein compound (I) undergoes chelation-enhanced fluorescence (CHEF) upon binding to Mg²⁺. In another aspect, the metal binding amino acid comprises a compound having the formula (II)

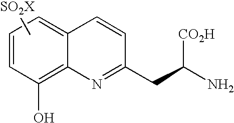

where X is OR″ or —NR″R′″; R″ is C₁₋₆ alkyl; and R′″ is hydrogen or C₁₋₆ alkyl. In an additional aspect, the metal binding amino acid comprises a compound of the formula (III)

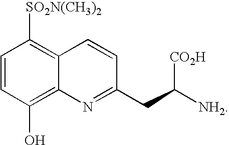

In one embodiment, fluorescence is detected by exciting the array at a wavelength of about 360 nm, and detecting emission at about 485 nm.

In one embodiment, the linker sequence connecting the kinase recognition site and the metal binding amino acid comprises a beta-turn sequence. Any beta-turn sequence known in the art can also be used in accordance with the present invention. Both L-amino acids and D-amino acids can be part of the beta-turn sequence. In one aspect, when the metal binding amino acid is located C-terminally to the kinase recognition site, the beta-turn sequence is Pro-Xaa, where Xaa can be any amino acid. In another aspect, when the metal binding amino acid is located N-terminally to the kinase recognition site, the beta-turn sequence is Xaa-Pro. Preferably, Xaa is Leu or Gly. Additional amino acids can also be present either before or after Pro, such that the beta-turn sequence can comprise up to 6 amino acids total, including Xaa and Pro. A portion of the beta-turn sequence can comprise a portion of the kinase recognition site.

The kinase recognition site is a ligand bound by the kinase, and which is phosphorylated by the kinase. Phosphorylation occurs at a serine, threonine, or tyrosine residue. Certain kinases only phosphorylate one type of residue, while other kinases are multi-functional and can phosphorylate more than one amino acid residue. Phosphorylation of a kinase recognition site can be predictive of in vivo phosphorylation of a target, or can be predictive of off-target (or non-specific) activity.

In a further embodiment, the polypeptide immobilized on the substrate comprises the sequence (Xaa)_{y}-(Xaa)ₚ-(Xaa)_{z}-Xaa-Pro-Sox (SEQ ID NO:1) or Sox-Pro-Xaa-(Xaa)_{z}-(Xaa)ₚ-(Xaa)_{y} (SEQ ID NO:2). In one aspect, y=4-20 amino acids, z=0-4 amino acids, and Xaa is any amino acid except that (Xaa)ₚ is selected from the group consisting of serine, threonine and tyrosine. In another aspect, y=6-10 amino acids, z=0-1 amino acids, and Xaa is any amino acid except that (Xaa)ₚ is selected from the group consisting of serine, threonine and tyrosine. In one aspect, the polypeptide comprises the sequence (Xaa)_{y}-Tyr-(Xaa)_{z}-Xaa-Pro-Sox (SEQ ID NO:3), wherein y=4-20 amino acids, and z=0-4 amino acids. In another aspect, the polypeptide comprises the sequence Sox-Pro-Xaa-(Xaa)_{z}-Ser-(Xaa)_{y} (SEQ ID NO:4) or Sox-Pro-Xaa-(Xaa)_{z}-Thr-(Xaa)_{y} (SEQ ID NO:5), wherein y=4-20 amino acids, and z=0-4 amino acids. Non-limiting examples of kinase recognition sites include LRRASLG (SEQ ID NO:6), recognized by Protein kinase A, EAIYAAPF (SEQ ID NO:7), recognized by Abl kinase, YIYGSFK (SEQ ID NO:8), recognized by Src kinase, and VEPLTPSG (SEQ ID NO:9), recognized by Erk.

For improved sensitivity, preferably the device includes one or more positive controls for use in making differential measurements. A positive control can include a kinase that autophosphorylates, or a positive control polypeptide.

The array can comprises more than 10, 20, 30, 40, 50, 60, 70, 80, 90, 100, 250, 500, 1000, 2000, 3000, 4000, 5000, 6000, 7000, 8000, 10,000 or 100,000 different polypeptides. The polypeptides can be present on the array at a density of between 100 polypeptides/cm² and 100,000 polypeptides/cm², at a density of between 1000 polypeptides/cm² and 70,000 polypeptides/cm², at a density of between 2500 polypeptides/cm² and 50,000 polypeptides/cm², at a density of between 5000 polypeptides/cm² and 50,000 polypeptides/cm², or at a density of between 10,000 polypeptides/cm² and 25,000 polypeptides/cm².

The array can contain a buffer capable of permitting the activity of a kinase. Typically, such buffer comprises a divalent cation and a high energy donor source, ATP. In one aspect, ATP is present at a physiological (i.e., mM) concentration. The buffer can also contain components such as salts, DTT, EGTA, phosphatase inhibitors, and combinations thereof.

The invention provides kits comprising the array of the invention. The kit of the invention will typically comprise the array described herein and one or more other containers comprising materials desirable from a commercial and user standpoint, including buffers, diluents, test compounds (kinase or phosphatase modulators), Control kinases or cell extracts, filters, needles, syringes, and package inserts with instructions for use.

A label can be present on the container to indicate that the array is used for a specific therapy or non-therapeutic application, and can also indicate directions for use. Directions and or other information can also be included on an insert which is included with the kit.

The invention also provides for a method of using the array, comprising contacting the array with a kinase capable of phosphorylating a kinase recognition sequence, wherein the phosphorylated polypeptide has increased affinity for a divalent cation than the unphosphorylated peptide, and wherein the divalent cation is in association with and increases the fluorescence of the metal binding amino acid.

In one embodiment, the invention comprises a method for identifying a target of a kinase, comprising contacting the kinase with a positionally addressable array comprising at least 10 different polypeptides immobilized on a substrate, wherein the polypeptide comprises a kinase recognition site joined by a beta-turn sequence to a metal binding amino acid, and identifying a polypeptide on the positionally addressable array that shows greater than an approximately 2 fold increase in fluorescence after being contacted with the kinase, wherein the increase in fluorescence indicates that the polypeptide is a target for the kinase. In other aspects, the increase in fluorescence is between approximately 2 and 20 fold, between approximately 2 and 5 fold, or between approximately 2 and 10 fold. In other aspects, the rate of phosphorylation can be monitored in real-time, and can be used to determine whether a kinase target is an on-target or an off-target.

In yet another embodiment, the invention encompasses a method for identifying a compound that modulates kinase activity, comprising contacting a kinase with a positionally addressable array comprising at least 10 different polypeptides immobilized on a substrate, wherein the polypeptide comprises a kinase recognition site joined by a linker polypeptide to a metal binding amino acid in the presence of a test compound, a divalent cation, and ATP, and determining whether fluorescence of the polypeptide is modulated in the presence of the test compound, wherein a change in fluorescence is an indication that the test compound modulates kinase activity.

It is contemplated that isolated kinases can be used in conjunction with the arrays of the invention. Alternatively, cell membranes, or crude cellular extracts can also be used with the arrays.

Generally, polypeptide arrays are created using (1) in situ photolithography, (2) in situ SPOT synthesis, or (3) contact printing (also called spotting). Methods for the synthesis of polypeptide arrays are well-known in the art and are generally described herein.

One method of preparing polypeptide arrays involves photolithographic techniques using photocleavable protecting groups. Briefly, the method includes attaching photoreactive groups to the surface of a substrate, exposing selected regions of the substrate to light to activate those regions, attaching a monomer with a photoremovable group to the activated regions, and repeating the steps of activation and attachment until macromolecules of a length and sequence are synthesized.

SPOT-synthesis is also an in situ synthesis method, but it does not use photochemical reactions for deprotection of the N-terminal amino group of the growing peptide chain. SPOT-synthesis comprises the dispensing of a small volume of solutions containing FMOC-amino acids and other coupling reagents to a designated stop on a membrane. Subsequently, deprotection and coupling steps synthesize the biomolecule on the substrate to form a peptide array.

The contact printing array method makes use of an automatic spotter to spot nanoliter droplets of pre-synthesized peptide/protein solutions onto a suitably derivatized solid surface, i.e. glass surface. By this approach, each peptide is synthesized only once in a bulk quantity and multiple spots containing the peptide are created by printing using a spotter.

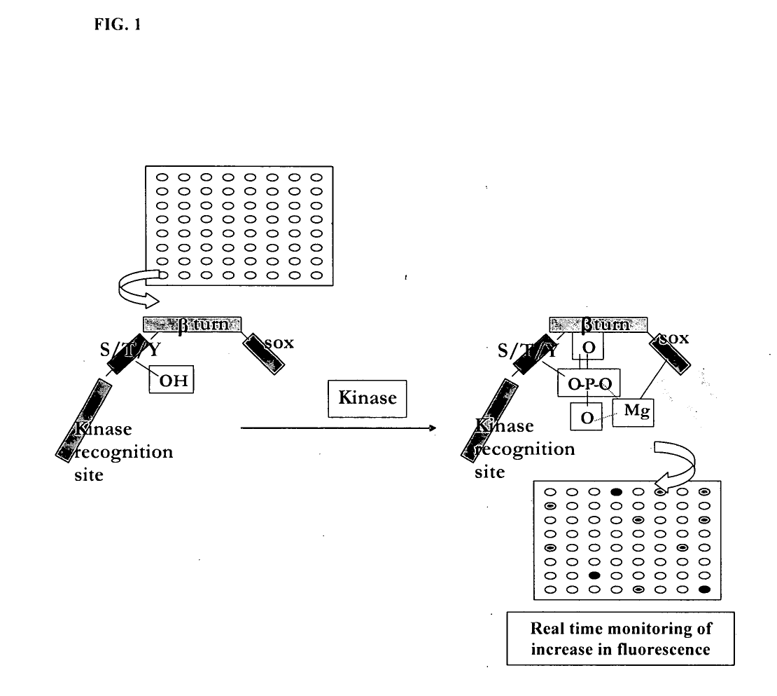

FIG. 1 shows an exemplary polypeptide array of the invention, containing a plurality of polypeptides, each of which contains a kinase recognition sequence containing a phosphorylation site (i.e., serine, threonine, or tyrosine), connected to a metal binding amino acid (i.e. Sox) via a linker sequence. In this embodiment, the linker sequence is a beta-turn sequence. The array is contacted with a kinase, which binds to target kinase recognition sites, and phosphorylates the phosphorylation site. The phosphate group becomes associated with a divalent cation (i.e., Mg²⁺), which in turn interacts with the metal binding amino acid. Binding of the divalent cation to the metal binding amino acid increases the fluorescence of the amino acid. This can be detected optically without the addition of any further reagents. Methods using this array thus provide real-time quantification of enzyme specificity for particular sequences. While FIG. 1 shows an exemplary polypeptide that contains the target recognition site at the C-terminus and the metal binding amino acid at the N-terminus, it is understood that the relative locations of the two components can be reversed such that the kinase recognition site is at the N-terminus and the metal binding amino acid is at the C-terminus. It is also understood that the polypeptides can be flanked by additional amino acid sequences.

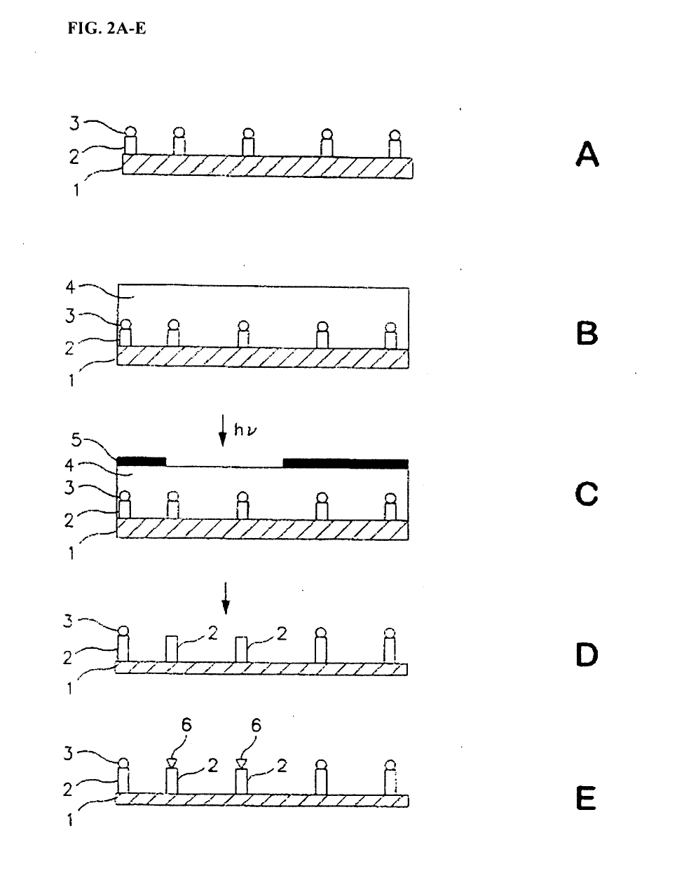

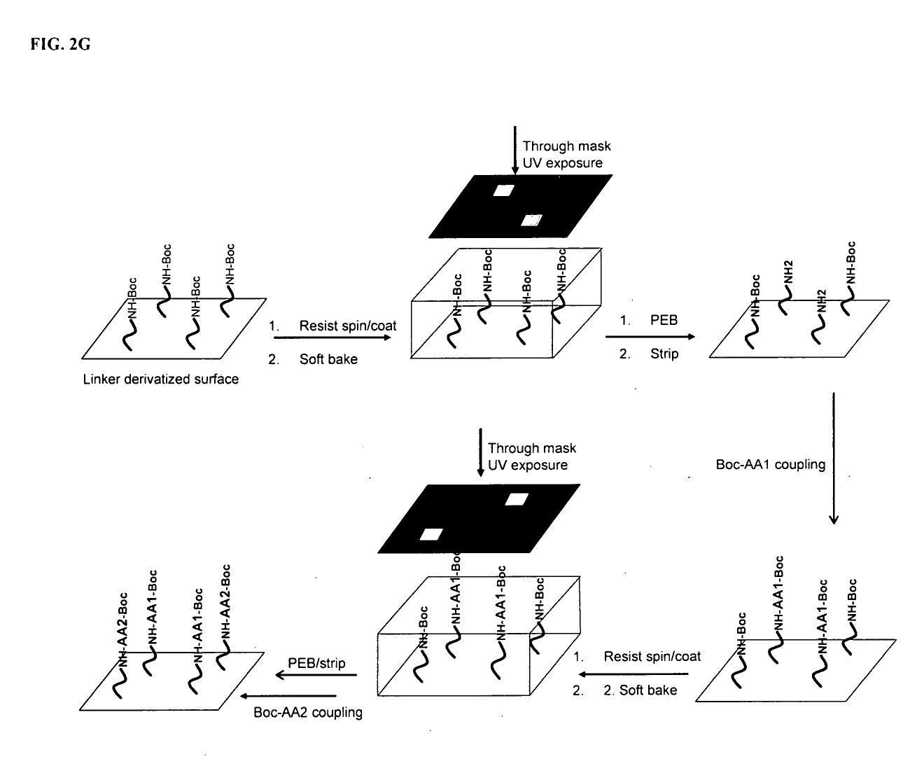

A method for synthesizing polymers within one or more selected region(s) of a solid support is shown in FIGS. 2A-E and FIG. 2G. In particular, FIG. 2G is a three-dimensional perspective of solid state synthesis of biomolecules on a microarray, which is described in the examples of this application. In general, the method includes attachment of a first building block molecule 2, for example, an amino acid or linker (or spacer) molecule, to the surface of a substrate 1. Additionally, mixtures of different building blocks 2 may also be used. For example, in FIG. 2A a first building block 2 can be an amino acid that is attached to a substrate 1 that is comprised of amino-functionalized glass, through the formation of a peptide bond between the carboxylate of the amino acid and the amine group of the glass. The terminal bond-forming site of the building block 2 is protected with a protecting group 3. For example, the α-amino group of an amino acid can be protected with an N-protecting group 3 to prevent unwanted reactivity. If necessary, a side chain of the building block (for example, an R group of an amino acid) may also have a protecting group. Suitable protecting groups include, for example, t-butoxycarbonyl (t-BOC), 2-(4-biphenylyl)-2-oxycarbonyl, and fluorenylmethoxycarbonyl (FMOC). Advantageously, embodiments of the present invention are not limited to the type of acid- or base-removable protective group or building block selected.

Referring now to FIG. 2B, once the first polymer building block has been attached to a substrate, a layer of photoresist 4 is deposited over the substrate 1 surface. In embodiments of the invention, the photoresist layer can be created from a solution comprising a polymer, a photosensitizer, and a photo-active compound or molecule in a solvent. The photoresist can be applied using any method known in the art of semiconductor manufacturing for the coating of a wafer with a photoresist layer, such as for example, the spin-coating method. The photoresist-coated substrate is then baked to remove excess solvent from the photoresist for film uniformity.

In FIG. 2C, a photomask 5 (the photomask can be a physical mask or any other source capable of projecting pattern image on the surface, for example, a micro-mirror) is applied over photoresist layer 4. The photomask 5 may be applied using standard techniques and materials used in the semiconductor fabrication industry. For example, the photomask 5 may be a transparent pane, such as a quartz pane, having an emulsion or metal film on a surface creating the mask pattern. Suitable metals include chromium. The pattern of the mask is chosen so that regions on the surface of the substrate can be selectively activated for polymer synthesis. Radiation, for example, ultra violet radiation (UV) or deep ultraviolet radiation (DUV), may then be directed through the photomask 5 onto the photoresist layer. The photoresist 4 is exposed in those regions of the mask that are transparent to the impinging radiation. In general, the device used for creating a pattern in the photoresist can be a physical mask or any other source capable of projecting a pattern image, for example a micromirror.

The exposure of the photoresist 4 to radiation generates cleaving reagents (species that catalyze the removal of a protective group, for example) in the exposed portion of the photoresist layer 4. The generation of cleaving reagents in the photoresist may be the result of a number of processes. For example, the cleaving reagent may result from the direct radiation-induced decomposition of or chemical transformation of a photoactive cleavage reagent precursor compound. Alternatively or in addition, generation of the cleaving reagent may occur through the absorption of light by a photosensitizer followed by reaction of the photosensitizer with the cleavage reagent precursor, energy transfer from the photosensitizer to the cleavage reagent precursor, or a combination of two or more different mechanisms.

As a result of the radiation-induced generation of the cleaving reagent (catalyst), the protecting groups 3 are cleaved from the molecules 2 under the exposed area(s) of the photoresist. The molecules 2 located under the unexposed masked regions remain unreacted. The cleaving process leading to the removal of the protecting groups 3 may, for example, be acid-catalyzed cleavage or base-catalyzed cleavage. The chemistry of the process will depend on the type of protecting groups 3 and on the type of cleaving reagents that are generated in the photoresist upon radiation exposure. For example, if the protecting group 3 is t-BOC, acid cleavage can be used. Acids may be generated in the photoresist, for example, through the exposure of sulfonium or halonium salts to radiation. If the protecting group is FMOC, for example, then base cleavage can be used. Cleavage can be accomplished through the reaction of a photogenerated amine or diamine through a decarboxylation process. The rate of protecting group removal can be accelerated by heating the substrate after the exposure to radiation (post exposure bake). The post exposure bake (PEB) serves multiple purposes in photoresist processing. First, the elevated temperature of the bake drives diffusion of the photoproducts. A small amount of diffusion can be useful in minimizing the effects of standing waves, periodic variations in exposure dose throughout the depth of the film that result from interference of incident and reflected radiation. Another purpose of the PEB is to drive the acid-catalyzed reaction. Chemical amplification is important because it allows a single photoproduct to cause many solubility-switching reactions, thus increasing the sensitivity of these photoresist systems.

Subsequent to the exposure of the masked substrate to radiation, the photoresist is removed. The photoresist layer 4 may be removed using acetone or another similar suitable solvent. The resulting surface-modified substrate is shown schematically in FIG. 2D. In this structure, there are three regions shown: two regions that have protected molecules and a region having deprotected molecules. The deprotected molecules are available for further reaction, such as for example, a peptide-bond forming coupling reaction whereas the molecules that retain their protective groups are not available for further reaction. Solid phase peptide synthesis can be carried out using standard techniques well-known in the art. FIG. 2E shows a structure resulting from the reaction of the deprotected surface-attached molecules. In FIG. 2E, a building block 6 has been added to molecule 2. Building block 6 may be the same or different from molecule 2. The building block 6 is protected with a protecting group to prevent unwanted reactions.

The processes illustrated in FIGS. 2A-E may be repeated to form polymers on the substrate surface. Through the selection of different mask configurations, different polymers comprising building blocks 2 and 6-10 may be formed in regions upon the surface, as shown schematically in FIG. 2G. In the case where the building blocks are amino acids, peptides having the same or different known sequences are formed in known regions on the surface of the substrate. In general, polymers containing from about 2 to about 50 mers (polymeric units) can be created. In embodiments of the invention peptides having a length of about 6 to about 20 amino acids are created.

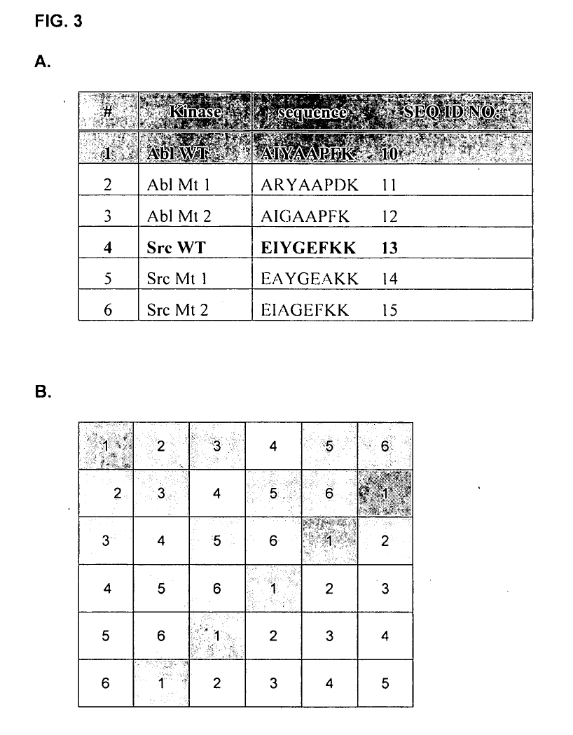

FIG. 3A shows exemplary wild-type and mutant kinase recognition sites for Abl and Src, SEQ ID NOs: 10-15. FIG. 3B demonstrates an exemplary array containing multiple repeats of these sequences. These arrays were generated using the in situ methods described generally in FIG. 2.

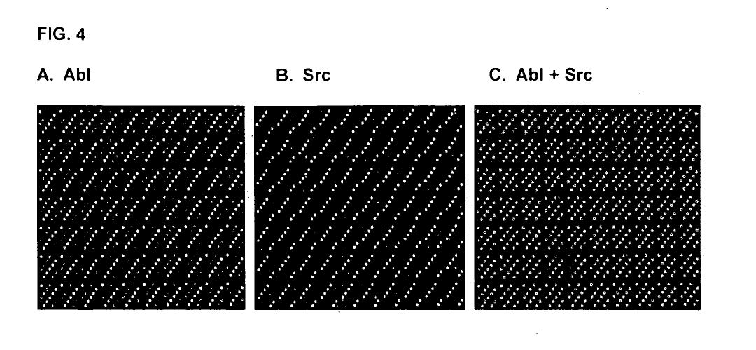

FIGS. 4A-C show fluorescence of selected spots on the array after incubation with Abl alone (A), Src alone (B), or a combination of Abl and Src (C). Comparing the arrays with the schematic of FIG. 3B indicates that in (A), the Abl wild type recognition site, SEQ ID NO:10, was phosphorylated, in (B), the Src wild type recognition site, SEQ ID NO:13, was phosphorylated, and in (C), both the Abl and Src wild type recognition sites were phosphorylated. The mutated sites were not phosphorylated upon treatment with either or both of the kinases.

Any unreacted deprotected chemical functional groups may be capped at any point during a synthesis reaction to avoid or to prevent further bonding at such molecule. In general, capping reagents can be a reagent that prevents further reactivity at the site of polymer chain formation. Capping groups cap deprotected functional groups by, for example, binding with the unreacted amino functions to form amides. Capping agents suitable for use in an embodiment of the invention include: acetic anhydride, n-acetylimidazole, isopropenyl formate, fluorescamine, 3-nitrophthalic anhydride and 3-sulfopropionic anhydride.

Substrate materials useful in embodiments of the present invention include, for example, silicon, bio-compatible polymers such as, for example poly(methyl methacrylate) (PMMA) and polydimethylsiloxane (PDMS), glass, SiO₂ (such as, for example, a thermal oxide silicon wafer such as that used by the semiconductor industry), quartz, silicon nitride, functionalized glass, gold, platinum, and aluminum. Functionalized surfaces include for example, amino-functionalized glass, carboxy functionalized glass, and hydroxy functionalized glass. Additionally, a substrate may optionally be coated with one or more layers to provide a surface for molecular attachment or functionalization, increased or decreased reactivity, binding detection, or other specialized application. Substrate materials and or layer(s) may be porous or non-porous. For example, a substrate may be comprised of porous silicon.

Photoresist formulations useful in the present invention include a polymer, a solvent, and a radiation-activated cleaving reagent. Useful polymers include, for example, poly(methyl methacrylate) (PMMA), poly-(methyl isopropenyl ketone) (PMPIK), poly-(butene-1-sulfone) (PBS), poly-(trifluoroethyl chloroacrylate) (TFECA), copolymer-(α-cyano ethyl acrylate-α-amido ethyl acrylate (COP), and poly-(2-methyl pentene-1-sulfone). Useful solvents include, for example, propylene glycol methyl ether acetate (PGMEA), ethyl lactate, and ethoxyethyl acetate. The solvent used in fabricating the photoresist may be selected depending on the particular polymer, photosensitizer, and photo-active compound that are selected. For example, when the polymer used in the photoresist is PMMA, the photosensitizer is Isopropyl-9H-thioxanthen-9-one (ITX), and the photoactive compound is diphenyliodonium chloride, PGMEA or ethyl lactate may be used as the solvent.

In exemplary photoresist formulations, the mass concentration of the polymer may between about 5% and about 50%, the mass concentration of a photosensitizer may be up to about 20%, the mass concentration of the photo-active compound may be between about 1% and 10%, the balance comprising a suitable solvent. After the photoresist is deposited on the substrate, the substrate typically is heated to form the photoresist layer. Any method known in the art of semiconductor fabrication may be used to for depositing the photoresist solution. For example, the spin coating method may be used in which the substrate is spun typically at speeds between about 1,000 and about 5,000 revolutions per minute for about 30 to about 60 seconds. The resulting wet photoresist layer has a thickness ranging between about 0.1 μm to about 2.5 μm.

Catalysts for protective group removal (also referred to as cleaving reagents) useful in the present invention include acids and bases. For example, acids can be generated photochemically from sulfonium salts, halonium salts, and polonium salts. Sulfonium ions are positive ions, R₃S⁺, where R is, for example, a hydrogen or alkyl group, such as methyl, phenyl, or other aryl group. In general, halonium ions are bivalent halogens, R₂X⁺, where R is a hydrogen or alkyl group, such as methyl, phenyl, or other aryl group, and X is a halogen atom. The halonium ion may be linear or cyclic. Polonium salt refers to a halonium salt where the halogen is iodine, the compound R₂I⁺Y⁻, where Y is an anion, for example, a nitrate, chloride, or bromide.

Photogenerated bases include amines and diamines having photolabile protecting groups.

Optionally, the photoresists useful in the present invention may also include a photosensitizer. In general, a photosensitizer absorbs radiation and interacts with the cleavage reagent precursor, through one or more mechanisms, including, energy transfer from the photosensitizer to the cleavage reagent precursor, thereby expanding the range of wavelengths of radiation that can be used to initiate the desired catalyst-generating reaction. Useful photosensitizers include, for example, benzophenone and other similar diphenyl ketones, thioxanthenone, isopropylthioxanthenone, anthraquinone, fluorenone, acetophenone, and perylene. Thus, the photosensitizer allows the use of radiation energies other than those at which the absorbance of the radiation-activated catalyst is non-negligible.

A catalytic enhancer is a compound or molecule that is added to a photoresist in addition to a radiation-activated catalyst. A catalytic enhancer is activated by the catalyst produced by the radiation-induced decomposition of the radiation-activated catalyst and autocatalyticly reacts to further (above that generated from the radiation-activated catalyst) generate catalyst concentration capable of removing protecting groups. For example, in the case of an acid-generating radiation-activated catalyst, the catalytic enhancer is activated by acid and or acid and heat and autocatalyticly reacts to form further catalytic acid, that is, its decomposition increases the catalytic acid concentration. The acid produced by the catalytic enhancer removes protecting groups from the growing polymer chain.

In general, methods according to the disclosed invention are useful for the synthesis of polymers on a substrate.

### EXAMPLES

### Example 1

Referring to FIG. 1, an array can be generated containing a plurality of polypeptides. The polypeptides can be synthesized and spotted on the array, or can be synthesized in situ. Each polypeptide comprises a kinase recognition site connected by a beta-turn sequence to a metal binding amino acid. The fluorescence signal is generated due to an increase in the fluorescence of the metal binding amino acid (i.e. Sox) upon chelation of a divalent cation. Phosphorylation increases the affinity of the kinase recognition site for magnesium, and hence the enhancement in fluorescent signal is phosphorylation specific and can be detected in real time. The real time detection of kinase activity by this methodology in a high density array based platform can therefore be a highly comprehensive as well as accurate monitoring of intracellular signaling events.

### Example 2

An array of 2520 peptides with 6 different amino acid sequences repeated 420 times was synthesized in situ. The six sequences were designed to represent wild type and two mutated versions of substrates of Abl and Src tyrosine kinases. The sequence of the peptides were: Abl (wt)—AIYAAPFK (SEQ ID NO:10); Abl (Mt 1)—ARYAAPDK (SEQ ID NO:11); Abl (Mt 2)—AIGAAPFK (SEQ ID NO:12); Src (wt)—EIYGEFKK (SEQ ID NO:13); Src (mt1)—EAYGEAKK (SEQ ID NO:14); and Src (mt2)—EIAGEFKK (SEQ ID NO:15), as shown in FIG. 3A.

The array was synthesized on amino derivatized silicon wafers coupled with dO-(N-Boc-2-aminoethyl)-O′—(N-diglycolyl-2-aminoethyl)hexaethyleneglycol molecule for spacing out the peptides from the surface. The peptides were synthesized in 70 blocks with the sequence layout in each block shown in FIG. 3B. The peptides were synthesized using photodeprotection and t-Boc protected amino acids.

The kinase substrate array was then assayed for detecting Abl and Src kinase activity. The protecting groups of the side groups of amino acids were cleaved by HBr/TFA treatment for one hour in the presence of the scavengers thioanisole and pentamethylbenzene. The array was subsequently neutralized by 5% DIEA treatment for 5 minutes. The array was blocked with 2% BSA for 1 hour for eliminating non-specific sticking of the kinase to the array. The array was then incubated with either the isolated Src or Abl kinase, or with a mixture of kinases in buffer containing 1 kinase, 200 μM ATP, 25 mM Tris-HCl (pH 7.5), 10 mM MgCl₂ and 2 mM DTT for 1 hour at 30° C. The kinase mixture was washed off and the phosphorylated peptides were detected by incubating the array with a phospho-specific fluorescent stain.

FIG. 4 shows the results of the kinase substrate array incubated with individual kinase, Abl or Src, or with mixture of the two. As expected, in the presence of one kinase, only the corresponding wild type substrate peptide (either SEQ NO:10 or 13, respectively) was phosphorylated. However, when incubated with the mixture of kinases, the wild type substrate peptides of both the kinases (both SEQ ID NOs:10 and 13) were phosphorylated, but the mutated substrate peptides were not phosphorylated.

This application discloses several numerical range limitations that support any range within the disclosed numerical ranges even though a precise range limitation is not stated verbatim in the specification because the embodiments of the invention could be practiced throughout the disclosed numerical ranges. Further, the entire disclosure of the patents and publications referred in this application, if any, are hereby incorporated herein in entirety by reference.

1. A positionally addressable array comprising 10 or more different polypeptides immobilized on a substrate, wherein the polypeptides comprise a kinase recognition sequence joined by a linker sequence to a metal binding amino acid comprising a compound having the formula (I) 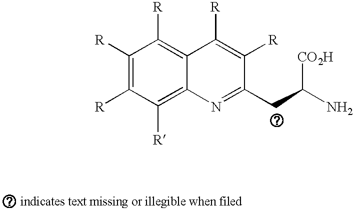
wherein at least one R group is —SO₂X, where X is OR″ or —NR″R′″;
R′ is hydroxy, amino, or thiol;
R″ is C₁₋₆ alkyl;
R′″ is hydrogen or alkyl; and
N is 1, 2, or 3; and
wherein compound (I) undergoes chelation-enhanced fluorescence (CHEF) upon binding to Mg²⁺.

2. The array of claim 1, wherein the metal binding amino acid comprises a compound having the formula (II) 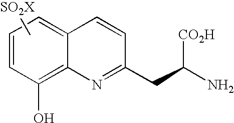
where X is OR″ or —NR″R′″;
R″ is C₁₋₆ alkyl; and
R′″ is hydrogen or C₁₋₆ alkyl.

3. The array of claim 1, wherein the metal binding amino acid comprises a compound of the formula (III)

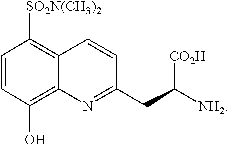

4. The array of claim 1, wherein the linker sequence comprises a beta-turn sequence.

5. The array of claim 4, wherein the beta-turn sequence comprises the sequence Xaa-Pro or Pro-Xaa, where Xaa is any amino acid.

6. The array of claim 5, wherein Xaa is Gly.

7. The array of claim 1, wherein the polypeptide comprises the sequence (Xaa)_{y}-(Xaa)ₚ-(Xaa)_{z}-Xaa-Pro-Sox (SEQ ID NO:1) or Sox-Pro-Xaa-(Xaa)_{z}-(Xaa)ₚ-(Xaa)_{y} (SEQ ID NO:2),
wherein y=4-20 amino acids,
z=0-4 amino acids, and
Xaa is any amino acid except that (Xaa)ₚ is selected from the group consisting of serine, threonine and tyrosine.

8. The array of claim 7, wherein the polypeptide comprises the sequence (Xaa)_{y}-Tyr-(Xaa)_{z}-Xaa-Pro-Sox (SEQ ID NO:3).

9. The array of claim 7, wherein the polypeptide comprises the sequence Sox-Pro-Xaa-(Xaa)_{z}-Ser-(Xaa)_{y} (SEQ ID NO:4) or Sox-Pro-Xaa-(Xaa)_{z}-Thr-(Xaa)_{y} (SEQ ID NO:5).

10. The array of claim 1, wherein the array comprises 100 or more different polypeptides.

11. The array of claim 1, wherein the polypeptides are present on the array at a density of between 5000 polypeptides/cm² and 50,000 polypeptides/cm².

12. The array of claim 1, further comprising a buffer capable of permitting the activity of a kinase, and comprising a divalent cation and a high energy donor source.

13. The array of claim 12, wherein the high energy donor source is ATP.

14. A method of using the array of claim 1, comprising contacting the array with a kinase capable of phosphorylating a kinase recognition sequence, wherein the phosphorylated polypeptide has increased affinity for a divalent cation than the unphosphorylated peptide, and wherein the divalent cation interacts with and increases the fluorescence of the metal binding amino acid.

15. A kit comprising the positionally addressable array of claim 1, and instructions means for its use.

16. A kit comprising the positionally addressable array of claim 1, and a kinase.

17. A kit comprising the positionally addressable array of claim 1, and a kinase inhibitor.

18. A method for identifying a target of a kinase, comprising
contacting the kinase with a positionally addressable array comprising at least 10 different polypeptides immobilized on a substrate, wherein the polypeptide comprises a kinase recognition site joined by a beta-turn sequence to a metal binding amino acid, and
identifying a polypeptide on the positionally addressable array that shows greater than an approximately 2 fold increase in fluorescence after being contacted with the kinase, wherein the increase in fluorescence indicates that the polypeptide is a target for the kinase.

19. The method of claim 18, wherein the beta-turn sequence comprises the sequence Xaa-Pro or Pro-Xaa, where Xaa is any amino acid.

20. The method of claim 18, wherein the polypeptide comprises the sequence (Xaa)_{y}-(Xaa)ₚ-(Xaa)_{z}-Xaa-Pro-Sox (SEQ ID NO:1) or Sox-Pro-Xaa-(Xaa)_{z}-(Xaa)ₚ-(Xaa)_{y} (SEQ ID NO:2),
wherein y=4-20 amino acids,
z=0-4 amino acids, and
Xaa is any amino acid except that (Xaa)ₚ is selected from the group consisting of serine, threonine and tyrosine.

21. The method of claim 18, wherein the metal binding amino acid comprises a compound of the formula (III)

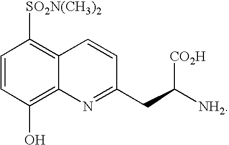

22. The method of claim 18, wherein the array comprises 100 or more different polypeptides.

23. The method of claim 18, wherein the polypeptides are present on the array at a density of between 5000 proteins/cm² and 50,000 proteins/cm².

24. The method of claim 18, where the array is contacted with the kinase in the presence of a buffer capable of permitting the activity of a kinase, comprising a divalent cation and ATP.

25. A method for identifying a compound that modulates kinase activity, comprising
contacting a kinase with a positionally addressable array comprising at least 10 different polypeptides immobilized on a substrate, wherein the polypeptide comprises a kinase recognition site joined by a linker polypeptide to a metal binding amino acid, wherein said contact is in the presence of a test compound, a divalent cation, and ATP, and
determining whether fluorescence of the polypeptide is modulated in the presence of the test compound, wherein a change in fluorescence is an indication that the test compound modulates kinase activity.

26. The method of claim 25, wherein the beta-turn sequence comprises the sequence Xaa-Pro or Pro-Xaa, where Xaa is any amino acid.

27. The method of claim 25, wherein the polypeptide comprises the sequence (Xaa)_{y}-(Xaa)ₚ-(Xaa)_{z}-Xaa-Pro-Sox (SEQ ID NO:1) or Sox-Pro-Xaa-(Xaa)_{z}-(Xaa)ₚ-(Xaa)_{y} (SEQ ID NO:2),
wherein y=4-20 amino acids,
z=0-4 amino acids, and
Xaa is any amino acid except that (Xaa)ₚ is selected from the group consisting of serine, threonine and tyrosine.

28. The method of claim 25, wherein the metal binding amino acid comprises a compound of the formula (III)

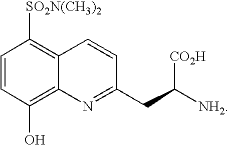

29. The method of claim 25, wherein the array comprises 100 or more different polypeptides.

30. The method of claim 25, wherein the polypeptides are present on the array at a density of between 5000 proteins/cm² and 50,000 proteins/cm².

31. The method of claim 25, wherein the test compound inhibits kinase activity.


SEQUENCE LISTING (15 sequences)

SEQ ID NO: 1 - protein, 28 aa, Artificial Sequence
  Description of Artificial Sequence Synthetic peptide
XXXXXXXXXXXXXXXXXXXXXXXXXXPX

SEQ ID NO: 2 - protein, 28 aa, Artificial Sequence
  Description of Artificial Sequence Synthetic peptide
XPXXXXXXXXXXXXXXXXXXXXXXXXXX

SEQ ID NO: 3 - protein, 28 aa, Artificial Sequence
  Description of Artificial Sequence Synthetic peptide
XXXXXXXXXXXXXXXXXXXXYXXXXXPX

SEQ ID NO: 4 - protein, 28 aa, Artificial Sequence
  Description of Artificial Sequence Synthetic peptide
XPXXXXXSXXXXXXXXXXXXXXXXXXXX

SEQ ID NO: 5 - protein, 28 aa, Artificial Sequence
  Description of Artificial Sequence Synthetic peptide
XPXXXXXTXXXXXXXXXXXXXXXXXXXX

SEQ ID NO: 6 - protein, 7 aa, Artificial Sequence
  Description of Artificial Sequence Synthetic peptide
LRRASLG

SEQ ID NO: 7 - protein, 8 aa, Artificial Sequence
  Description of Artificial Sequence Synthetic peptide
EAIYAAPF

SEQ ID NO: 8 - protein, 7 aa, Artificial Sequence
  Description of Artificial Sequence Synthetic peptide
YIYGSFK

SEQ ID NO: 9 - protein, 8 aa, Artificial Sequence
  Description of Artificial Sequence Synthetic peptide
VEPLTPSG

SEQ ID NO: 10 - protein, 8 aa, Artificial Sequence
  Description of Artificial Sequence Synthetic peptide
AIYAAPFK

SEQ ID NO: 11 - protein, 8 aa, Artificial Sequence
  Description of Artificial Sequence Synthetic peptide
ARYAAPDK

SEQ ID NO: 12 - protein, 8 aa, Artificial Sequence
  Description of Artificial Sequence Synthetic peptide
AIGAAPFK

SEQ ID NO: 13 - protein, 8 aa, Artificial Sequence
  Description of Artificial Sequence Synthetic peptide
EIYGEFKK

SEQ ID NO: 14 - protein, 8 aa, Artificial Sequence
  Description of Artificial Sequence Synthetic peptide
EAYGEAKK

SEQ ID NO: 15 - protein, 8 aa, Artificial Sequence
  Description of Artificial Sequence Synthetic peptide
EIAGEFKK